(19) United States
(12) Patent Application Publication
(10) Pub. No.: US 2007/0287436 A1
(43) Pub. Date: Dec. 13, 2007

(54) System and method for social interaction

(75) Inventor: Robert C. Lovell, Leesburg, VA (US)

Correspondence Address: PAUL, HASTINGS, JANOFSKY & WALKER LLP, 875 15th Street, NW, Washington, DC, 20005, US

(73) Assignee: Sybase 365, Inc.

(21) Appl. No.: 11/727,691

(22) Filed: Mar. 28, 2007

Related U.S. Application Data
(60) Provisional application No. 60/789,913, filed on Apr. 7, 2006.

(51) Int. Cl. H04M 3/493

(52) U.S. Cl. 455/414.2

(57) ABSTRACT

A service that leverages established wireless messaging paradigms such as, possibly inter alia, Short Message Service and Multimedia Message Service to allow Mobile Subscribers to use their Wireless Devices to become aware of, join, and subsequently fully participate in Dynamic Social Group (e.g., a collection of people who dynamically come together; discuss, interact regarding, etc. some topic, event, etc.; and then disband). The service may optionally leverage the capabilities of a Messaging Inter-Carrier Vendor.

This application claims the benefit of U.S. Provisional Patent Application No. 60/789,913, filed on Apr. 4, 2006, which is herein incorporated by reference in its entirety.

### BACKGROUND

1. Field of the Invention

The present invention relates generally to telecommunications services. More particularly, the present invention relates to capabilities that enhance substantially the value and usefulness of various wireless messaging paradigms including, inter alia, Short Message Service (SMS) and Multimedia Message Service (MMS).

2. Background of the Invention

As the ‘wireless revolution’ continues to march forward the importance to a Mobile Subscriber (MS), for example a user of a Wireless Device (WD) such as a mobile telephone, BlackBerry, etc. that is serviced by a Wireless Carrier (WC), of their WD grows substantially while, simultaneously, the challenges that are associated with offering to MSs new and useful services, particularly within a truly ubiquitous cross-WC environment, similarly increase.

Additionally, the importance, relevance, etc. of what may be referred to as Dynamic Social Groups (DSGs)—e.g., a collection of people who dynamically come together; discuss, interact regarding, etc. some topic, event, etc.; and then disband—is unquestioned. Technological advances have certainly impacted DSGs; see for example Howard Rheingold's volume “Smart Mobs: The Next Social Revolution” (Perseus Books Group, 2002).

The present invention extends key elements of wireless technology to allow MSs to fully participate in an entirely new class of DSGs and addresses various of the challenges that are associated with same.

### SUMMARY OF THE INVENTION

Embodiments of the present invention provide mechanisms through which the occurrence of DSGs may be identified and a MS' WD may be utilized to receive notification of, and optionally join and participate in, such DSGs when, possibly inter alia, the DSGs meet or match various MS-defined criteria.

In an embodiment of the invention a SP (1) generates an indication of the occurrence of a DSG, said indication based at least in part on preference information that was previously supplied by a MS, (2) performs one or more processing steps on said indication, (3) conditionally generates one or more notification messages, and (4) dispatches said notification messages to a WD of said MS.

Another embodiment of the invention includes a SP (1) receiving a participation message from a MS, (2) performing one or more processing steps on the participation message, and (3) conditionally dispatching the processed participation message to one or more members of a DSG.

Another embodiment of the invention includes a SP assigning a moderator to a DSG.

Another embodiment of the invention includes a SP proposing a candidate meeting place to one or more members of a DSG.

In yet another embodiment of the invention there is provided a method of managing a Dynamic Social Group that includes determining whether a mobile subscriber, who has previously registered to be associated with a predetermined Dynamic Social Group, should be notified that the predetermined Dynamic Social Group is forming; sending at least one of a short message service (SMS) and a multimedia message service (MMS) message to the mobile subscriber inviting the mobile subscriber to join the Dynamic Social Group; receiving from the mobile subscriber input to be made available to the Dynamic Social Group; and making the input from the mobile subscriber available to the Dynamic Social Group.

This embodiment may also further include supplying a different version of the input from the mobile subscriber to at least one member of the Dynamic Social Group.

These and other features of the embodiments of the present invention along with their attendant advantages will be more fully appreciated upon a reading of the following detailed description in conjunction with the associated drawings.

### BRIEF DESCRIPTION OF THE DRAWINGS

FIG. 1 is a diagrammatic presentation of an exemplary Messaging Inter-Carrier Vendor (MICV).

FIG. 2 illustrates various of the exchanges or interactions that are supported by aspects of the present invention.

FIG. 3 illustrates further of the exchanges or interactions that are supported by aspects of the present invention.

FIG. 4 is a diagrammatic presentation of aspects of an exemplary Service Provider (SP) Application Server (AS).

### DETAILED DESCRIPTION OF THE INVENTION

The present invention may leverage the capabilities of a centrally-located, full-featured MICV facility. Reference is made to U.S. Pat. No. 7,154,901 entitled “INTERMEDIARY NETWORK SYSTEM AND METHOD FOR FACILITATING MESSAGE EXCHANGE BETWEEN WIRELESS NETWORKS,” and its associated continuations, for a description of a MICV, a summary of various of the services/functions/etc. that are performed by a MICV, and a discussion of the numerous advantages that arise from same. U.S. Pat. No. 7,154,901 is incorporated herein by reference.

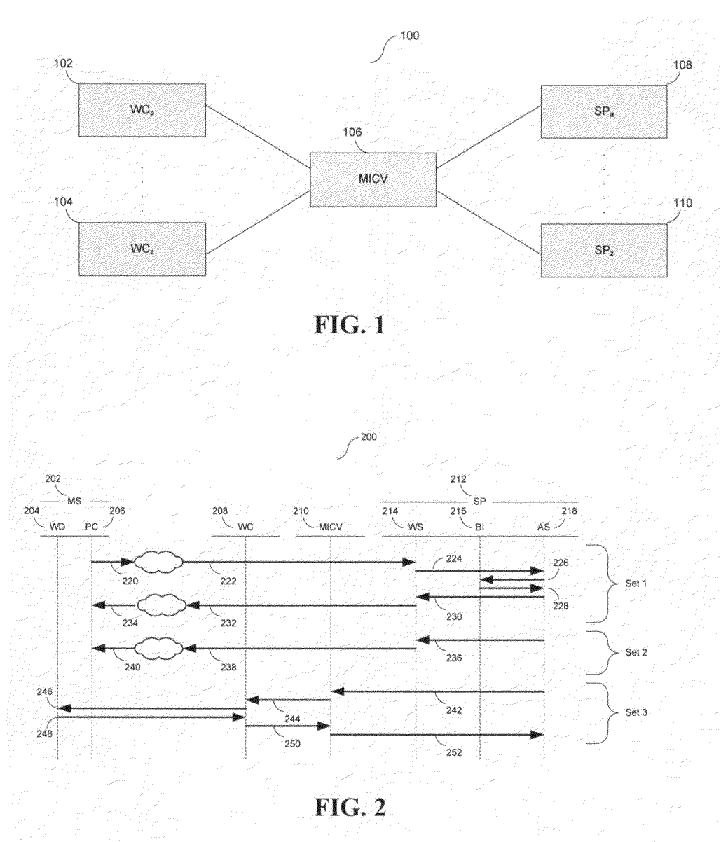

As depicted by architecture 100 in FIG. 1, a MICV 106 may be disposed between, possibly inter alia, multiple WCs (WCₐ 102→WC_{z} 104) on one side and multiple SPs (SPₐ 108→SP_{z} 110) on the other side thus ‘bridging’ all of the connected entities. A MICV thus, as one simple example, may offer various routing, formatting, delivery, value-add, etc. capabilities that provide, possibly inter alia:

1) A WC (and, by extension, all of the MSs that are serviced by the WC) with ubiquitous access to a broad universe of CPs, and

2) A SP with ubiquitous access to a broad universe of WCs (and, by extension, to all of the MSs that are serviced by the WCs).

While the discussion below will include a MICV it will be readily apparent to one of ordinary skill in the relevant art that other arrangements are equally applicable and indeed are fully within the scope of the present invention.

In the discussion below the present invention is described and illustrated as being offered by a SP. A SP may, for example, be realized as a third-party service bureau, an element of a WC or a landline carrier, an element of a MICV, multiple third-party entities working together, etc.

In the discussion below reference is made to messages that are sent, for example, between a MS and a SP. As set forth below, a given ‘message’ sent between a MS and a SP may actually comprise a series of steps in which the message is received, forwarded and routed between different entities, including possibly inter alia a MS, a WC, a MICV, and a SP. Thus, unless otherwise indicated, it will be understood that reference to a particular message generally includes that particular message as conveyed at any stage between an origination source, such as for example a MS, and an end receiver, such as for example a SP. As such, reference to a particular message generally includes a series of related communications between, for example, a MS and a WC; a WC and a MICV; a MICV and a SP; etc. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

To better understand the particulars of the present invention consider for a moment a simple hypothetical example—SP offers aspects of the instant invention and Mary, a MS, uses SP's service.

FIG. 2 illustrates various of the exchanges or interactions that might occur under a portion of our hypothetical example. Of interest and note in the diagram are the following entities:

MS 202 WD 204. For example, Mary's WD such as a mobile telephone, BlackBerry, PalmPilot, etc.

MS 202 Personal Computer (PC) 206. For example, one of Mary's home, work, etc. PCs.

WC 208. The provider of service for Mary's WD.

MICV 210. As noted above the use of a MICV, although not required, provides significant advantages.

SP 212 Web Server (WS) 214. A publicly-available Web site that is optionally provided by SP.

SP 212 Billing Interface (BI) 216. A consolidated interface that SP may use to easily reach, inter alia, one or more external entities such as a credit card or debit card clearinghouse, a carrier billing system, a service bureau that provides access to multiple carrier billing systems, etc.

SP 212 Application Server (AS) 218. Facilities that provide key elements of the instant invention (and which will be described below).

In FIG. 2 the exchanges that are collected under the designation Set 1 represent the activities that might take place as Mary 202 completes a registration process with SP 212. For example:

A) Mary 202 uses one of her PCs 206 to visit SPₓ's WS 214 to, possibly among other things, complete a service registration process (220→222).

B) SP's WS 214 interacts with SP's AS 218 to, possibly among other things, commit some or all of the information that Mary provided to a data repository (e.g., a database), optionally complete a billing transaction, etc. (224).

C) As appropriate and as required SPₓ's BI 216 completes a billing transaction (226→230).

D) SPₓ's WS 214 responds appropriately (e.g., with the presentation of a confirmation message, etc.) (232→234).

The specific exchanges that were described above (as residing under the designation Set 1) are illustrative only and it will be readily apparent to one of ordinary skill in the relevant art that numerous other exchanges are easily possible and indeed are fully within the scope of the present invention. As just one example, the registration process may be completed through any combination of one or more channels including, inter alia, the World Wide Web (WWW via, for example, a Web site that is operated by SP 212), wireless messaging (SMS, MMS, etc.), e-mail messages, conventional mail, telephone, etc.

During the registration process described above a range of information may be captured from a MS including, inter alia:

A) Identifying Information. For example, possibly among other things, a unique identifier and a password, optionally a pseudonym or handle, name, address, age, landline and wireless telephone numbers, e-mail addresses, instant messenger names/identifiers, etc.

B) Preference Information. Any number of items including, as simple examples, likes and dislikes (e.g., colors, foods, religion, politics, movies, music, books, TV shows, clothing, automobiles, etc.), census-like data (e.g., household makeup, salary, recent purchases, planned purchases, family history, etc.), etc.

E) Billing Information. Different service billing models may be offered including, inter alia, a fixed one-time charge, a recurring (monthly, etc.) fixed charge, a recurring (monthly, etc.) variable charge, a per-minute-of-use charge, etc. Different payment mechanisms may be supported including, possibly among other things, credit or debit card information, authorization to place a charge on a MS's phone bill, etc.

The specific pieces of information that were described above are illustrative only and it will be readily apparent to one of ordinary skill in the relevant art that numerous other pieces of information (e.g., additional Preference Information, scheduled daily/weekly/etc. reporting desired and/or on-demand reporting desired, etc.) are easily possible and indeed are fully within the scope of the present invention.

As noted above the information that Mary provided during the registration process may be preserved in a data repository (e.g., a database) and may optionally be organized as a MS Profile.

The content of Mary's profile may be augmented by SP to include, as just a few examples of the many possibilities, internal and/or external demographic, psychographic, sociological, etc. data.

As noted above, a SP's BI may optionally complete a billing transaction. The billing transaction may take any number of forms and may involve different external entities (e.g., a WC's billing system, a carrier billing system service bureau, a credit or debit card clearinghouse, etc.). The billing transaction may include, inter alia:

1) The appearance of a line item charge on the bill or statement that a MS receives from her WC. Exemplary mechanics and logistics associated with this approach are described in pending U.S. patent application Ser. No. 10/837,695 entitled “SYSTEM AND METHOD FOR BILLING AUGMENTATION,” which is incorporated herein by reference. Other ways of completing or performing line item billing are easily implemented by those skilled in the art.

2) The charging of a credit card or the debiting of a debit card.

In FIG. 2 the exchanges that are collected under the designation Set 2 represent the activities that might take place as SP 212 dispatches to Mary 202 one or more confirmation e-mail messages (236→240).

The specific exchanges that were described above (as residing under the designation Set 2) are illustrative only and it will be readily apparent to one of ordinary skill in the relevant art that numerous other exchanges are easily possible and indeed are fully within the scope of the present invention.

In FIG. 2 the exchanges that are collected under the designation Set 3 represent the activities that might take place as SP's AS 218 dispatches one or more confirmation SMS, MMS, etc. messages to Mary's WD 204 and Mary 202 replies or responds to the message(s) (242→252). In the instant example the messages are shown traversing a MICV 210.

The specific exchanges that were described above (as residing under the designation Set 3) are illustrative only and it will be readily apparent to one of ordinary skill in the relevant art that numerous other exchanges are easily possible and indeed are fully within the scope of the present invention.

The SP may employ a Short Code (SC) or a regular Telephone Number (TN) as its source address (and to which it would ask users of its service to direct any reply messages). While the abbreviated length of a SC (e.g., five digits for a SC administered by Neustar under the Common Short Code [CSC] program) incrementally enhances the experience of a MS (e.g., the MS need remember and enter only a few digits as the destination address of a reply message) it also, by definition, constrains the universe of available SCs thereby causing each individual SC to be a limited or scarce resource and raising a number of SC/CSC management, etc. issues. A description of a common (i.e., universal) short code environment may be found in pending U.S. patent application Ser. No. 10/742,764 entitled “UNIVERSAL SHORT CODE ADMINISTRATION FACILITY,” which is incorporated herein by reference.

The Set 1, Set 2, and Set 3 exchanges that were described above are illustrative only and it will be readily apparent to one of ordinary skill in the relevant art that numerous other exchanges, arrangements, etc. are easily possible and indeed are fully within the scope of the present invention.

To continue with our hypothetical example . . . . One or more processes within SP's AS may, on a scheduled basis or on-demand based on various trigger criteria, ‘sweep’ through the list of active DSGs (more about the creation of DSGs below) and optionally apply various elements of an MS' Profile to dynamically develop a set of MS-specific DSG lists (i.e., e.g., a list of DSGs that match various likes, interests, etc. of an MS and thus are of interest to the MS).

On request or demand from Mary, or on a scheduled basis, SP 212 may dispatch notification messages (SMS, MMS, etc.) to Mary. The notification messages may, possibly among other things, summarize all of the active DSGs, all of the active DSGs that match elements of Mary's profile, etc.

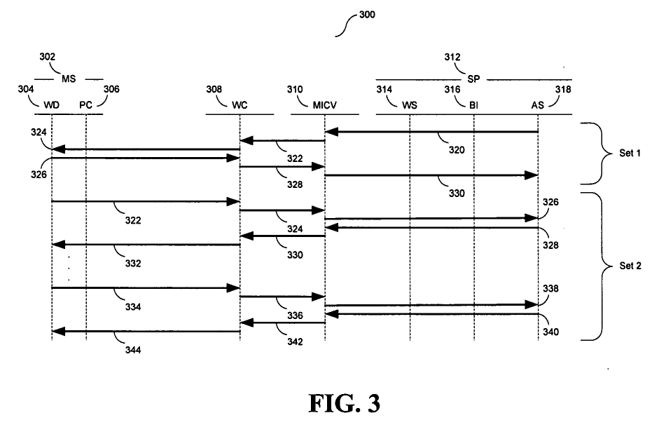

FIG. 3 illustrates various of the exchanges or interactions that might occur under this aspect of our hypothetical example. The entities that are depicted in FIG. 3 are the same as were depicted in, and described for, FIG. 2.

In FIG. 3 the exchanges that are collected under the designation Set 1 represent the activities that might take place as SP 312 alerts Mary 302 to, or notifies Mary 302 of, available DSGs:

A) SP's AS 318 dispatches one or more notification SMS, MMS, etc. messages to Mary's WD 304 (through, in the instant example, a MICV 310) (320→324).

B) Mary 302 optionally replies or responds to the notification message(s) (326→330).

The specific exchanges that were described above (as residing under the designation Set 1) are illustrative only and it will be readily apparent to one of ordinary skill in the relevant art that numerous other exchanges are easily possible and indeed are fully within the scope of the present invention.

In FIG. 3 the exchanges that are collected under the designation Set 2 represent the activities that might take place as Mary 302 (1) joins one or more DSGs (by, possibly inter alia, responding to a notification message and optionally receiving back one or more follow-up messages, 322→332) and (2) subsequently participates in one or more of the just-joined DSGs (334→344). DSG participation is described below.

The specific exchanges that were described above (as residing under the designation Set 2) are illustrative only and it will be readily apparent to one of ordinary skill in the relevant art that numerous other exchanges are easily possible and indeed are fully within the scope of the present invention.

The Set 1 and Set 2 exchanges that were described above are illustrative only and it will be readily apparent to one of ordinary skill in the relevant art that numerous other exchanges, arrangements, etc. are easily possible and indeed are fully within the scope of the present invention.

Upon receiving a request from Mary to join a DSG, SP 312 may optionally apply one or more authorization rules (for example, inter alia, age limits, adult content limits, etc.) prior to granting Mary entrance to the DSG.

Once Mary joins a DSG, SP 312 may optionally dispatch one or more notification SMS, MMS, etc. messages containing, possibly inter alia, instructions on how to participate in the DSG. For example, the instructions might indicate that to participate in a DSG SMS, MMS, etc. messages need to be directed to a specific SC/CSC, TN, etc., might need to contain a specific keyword or code, etc.

Once Mary has joined a DSG she may participate in it through any one of a number of different channels.

For example, she might compose (and subsequently dispatch to SP 312) an SMS, MMS, etc. message that SP 312 would (upon receipt) post to the DSG (i.e., distribute to the other participants of the DSG).

For example, she might take a photograph with her camera-equipped wireless device, compose an MMS message containing the photograph, then dispatch the message to SP 312 who would (upon receipt) post to the DSG (i.e., distribute to the other participants of the DSG). For certain classes of content (e.g., photographs, video clips, audio clips, etc.) a SP may, among other things, optionally send an appropriately “de-tuned” version of a message to certain participants of a DSG (e.g., participants who, as identified through their profile information, are unable to receive certain classes of content—they have an SMS-capable WD only, etc.).

The specific participation mechanisms that were described above are illustrative only and it will be readily apparent to one of ordinary skill in the relevant art that numerous other mechanisms are easily possible and indeed are fully within the scope of the present invention.

Mary may depart a DSG through any number of mechanisms including, possibly inter alia, following any instructions that she received previously (e.g., that might direct her to submit a special ‘I Am Done’ code or keyword), not submitting anything further to the DSG (upon which, e.g., a SP-maintained time-out mechanism may remove Mary from the DSG participant list), etc.

For purposes of privacy a SP may allow the participants of a DSG to initially join, and interact with, the group under a pseudonym or handle. A SP may optionally allow a participant of a DSG to subsequently reveal their true (user) identity.

A SP may optionally provide the participants of a DSG with one or more, possibly DSG-specific, help or help-like mechanisms. For example, a participant of a DSG might be allowed to request a roll-call of participants in the DSG (through which one or more notification messages—cataloging the DSG participants by name/pseudonym/handle—may be returned to the participants of the DSG), request that a moderator call them (possibly for an incremental fee that would be charged by a SP), etc.

A MS may submit to a SP a request for a DSG. Additionally, other interested third-parties (e.g., a movie studio, a magazine publisher, a TV network, etc.) may also submit to a SP a request for a DSG. Such requests may be completed through any combination of one or more channels including, inter alia, the World Wide Web (WWW via, for example, a Web site that is operated by a SP), wireless messaging (SMS, MMS, etc.), e-mail messages, conventional mail, telephone, etc.

A request for a DSG may also be accompanied by various definitional, descriptive, etc. information including, possibly inter alia, DSG name, subject area, start and end dates and times, optional maximum occupancy (e.g., maximum number of simultaneous participants), applicable SC(s)/TN(s)/etc., owner or sponsor, etc. The provided information may be preserved in a data repository (e.g., a database) within a SP and may optionally be organized as a DSG Profile.

A SP may optionally complete a billing transaction in connection with a request for a DSG. Different billing models may be offered including, inter alia, a fixed one-time charge, a recurring (monthly, etc.) fixed charge, a recurring (monthly, etc.) variable charge, a per-participant charge, etc. Different payment mechanisms may be supported including, possibly among other things, credit card or debit card, authorization to place a charge on a MS's phone bill (if the requestor of a DSG is a MS), etc. as (at least partially) described above.

For purposes of illustration consider the following hypothetical examples. A political party might sponsor a DSG in connection with fundraising activities, an upcoming election, an upcoming speech or appearance by a candidate, to collect focus group or polling data, etc. A movie studio might sponsor a DSG for an upcoming movie release. A book publisher or a bookstore chain might sponsor a DSG in connection with an upcoming book release while a music studio might sponsor a DSG for an upcoming release of a new music CD. A TV network, cable operator, etc. might sponsor a DSG in connection with a new TV show or for a specific episode of an ongoing TV show.

During the life of a DSG a SP may optionally offer advertising to participants of the DSG through periodic notification SMS, MMS, etc. messages.

During the life of a DSG a SP may assign a moderator to the DSG, possibly for some defined period of time, for any number of reasons. For example, possibly inter alia, a moderator may be requested by one or more participants in a DSG, may be voted for by some number of participants in a DSG, may be deemed required or necessary through monitoring by a SP of activity within a DSG, etc. A moderator of a DSG may be selected by a SP, possibly inter alia, randomly (from a list of candidate moderators possibly including some participants of the DSG), by vote (by some number of participants in the DSG), etc.

A SP may optionally charge an incremental fee for providing a moderator to a DSG. A SP may optionally distribute such an incremental fee across (i.e., charge such an incremental fee to) some or all of the participants of the DSG, the sponsor or originator of the DSG, etc.

A SP may allow MSs to volunteer to serve as a DSG moderator. A SP may award ‘credits’ to moderator volunteers and/or actual moderators.

Once created a DSG may exist for a pre-defined period of time. At a defined point before the end of the life of a DSG the participants of the DSG may receive one or more notification SMS, MMS, etc. messages announcing the upcoming end/demise of the DSG. The participants of the DSG may vote to continue or extend the DSG's life for a pre-defined amount of time. A SP may optionally distribute an incremental fee for such an extension across (i.e., charge such an incremental fee to) some or all of the participants of the DSG, the sponsor or originator of the DSG, etc.

A SP may optionally supply advertising, coupons, prizes, the accumulation of points for future redemption, etc. to various combinations of DSG sponsors, DSG participants, DSG moderators, etc.

Businesses may register with a SP as an advertiser and may provide advertising materials or content (including, possibly inter alia, text, images, audio, video, etc.) to the SP. A SP may optionally complete a billing transaction in connection with such a registration. Different offering models may be supported by a SP including, inter alia, a fixed number of impressions during a specified period of time, etc. Different billing models may be offered including, inter alia, a fixed one-time charge, a recurring (monthly, etc.) fixed charge, a recurring (monthly, etc.) variable charge, a per-impression charge, etc. Different payment mechanisms may be supported including, possibly among other things, credit card or debit card, etc. as (at least partially) described above.

Restaurants, bookstores, coffee shops, etc. may optionally register with a SP as candidate Meeting Place. A SP may optionally complete a billing transaction in connection with such a registration. Different billing models may be offered including, inter alia, a fixed one-time charge, a recurring (monthly, etc.) fixed charge, a recurring (monthly, etc.) variable charge, a per-use charge, etc. Different payment mechanisms may be supported including, possibly among other things, credit card or debit card, etc. as (at least partially) described above.

A SP may optionally leverage Location-Based Services (LBS) or similar services to alert DSG participants to the proximity of a candidate Meeting Place. For example, a SP may identify the number of DSG participants that are within some specific distance of a Meeting Place. For example, a SP may extend a Meeting Place invitation (including, possibly inter alia, directions to the Meeting Place, optional coupons or awards that may be redeemed at the Meeting Place, etc.) to one or more DSG participants.

A SP may optionally support the ability of one or more members of a DSG to ‘break away’ from the group and join a side forum. A SP may optionally distribute an incremental fee for such a capability across (i.e., charge such an incremental fee to) the specific DSG participants, the sponsor or originator of the DSG, etc. A side forum may exist for a specified duration and a SP may optionally provide for a life extension capability similar to the DSG life extension process that was described above.

The confirmation, notification, etc. message(s) that were described above may optionally contain an informational element—e.g., a relevant or applicable “factoid,” etc. The informational element may be selected statically (e.g., all generated messages are injected with the same informational text), randomly (e.g., a generated message is injected with informational text that is randomly selected from a pool of available informational text), or location-based (i.e., a generated message is injected with informational text that is selected from a pool of available informational text based on the current physical location of the recipient of the message as derived from, as one example, a LBS facility).

The confirmation, notification, etc. message(s) may optionally contain advertising—e.g., textual material if an SMS model is being utilized, or multimedia (images of brand logos, sound, video snippets, etc.) material if an MMS model is being utilized. The advertising material may be selected statically (e.g., all generated messages are injected with the same advertising material), randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, a LBS facility).

The confirmation, notification, etc. message(s) may optionally contain promotional materials (e.g., still images, video clips, etc.).

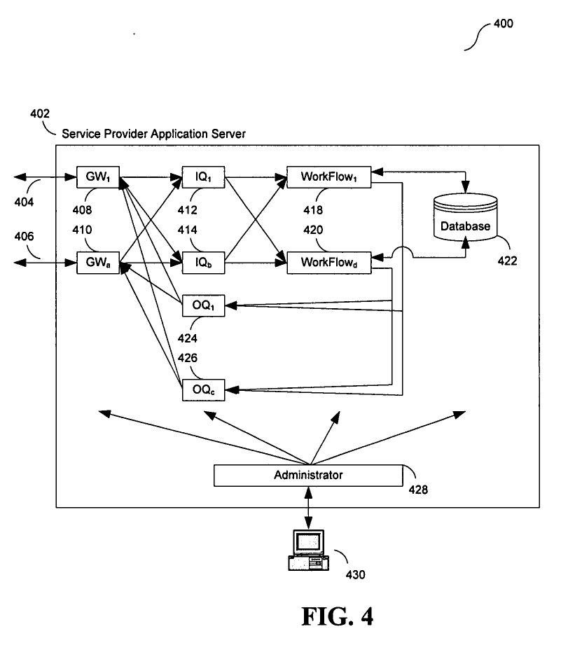

FIG. 4 provides a diagrammatic presentation of aspects of an exemplary SP AS 402. The illustrated AS 402 contains several key components—Gateways (GW₁ 408→GWₐ 410 in the diagram), Incoming Queues (IQ₁ 412→IQ_{b} 414 in the diagram), WorkFlows (WorkFlow₁ 418→WorkFlow_{d} 420 in the diagram), Database 422, Outgoing Queues (OQ₁ 424→OQ_{c} 426 in the diagram), and an Administrator 428. It will be readily apparent to one of ordinary skill in the relevant art that numerous other components are possible within an AS 402.

A dynamically updateable set of one or more Gateways (GW₁ 408→GWₐ 410 in FIG. 4) handle incoming and outgoing traffic (404→406). Incoming traffic is accepted and deposited on an intermediate or temporary Incoming Queue (IQ₁ 412→IQ_{b} 414) for subsequent processing. Processed artifacts are removed from an intermediate or temporary Outgoing Queue (OQ₁ 424→OQ_{c} 426) and then dispatched.

A dynamically updateable set of one or more Incoming Queues (IQ₁ 412→414 IQ_{b} in FIG. 4) and a dynamically updateable set of one or more Outgoing Queues (OQ₁ 424→OQ_{c} 426) operate as intermediate or temporary buffers for incoming and outgoing traffic.

A dynamically updateable set of one or more WorkFlows (WorkFlow₁ 418→WorkFlow_{d} 420 in FIG. 4) remove incoming traffic from an intermediate or temporary Incoming Queue (IQ₁ 412→IQ_{b} 414), perform all of the required processing operations, and deposit processed artifacts on an intermediate or temporary Outgoing Queue (OQ₁ 424→OQ_{c} 426). The WorkFlow component will be described more fully below.

The Database 422 that is depicted in FIG. 4 is a logical representation of the possibly multiple physical repositories that may be implemented to support, inter alia, configuration, profile, monitoring, alerting, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

The Administrator 428 that is depicted in FIG. 4 provides management or administrative control over all of the different components of an AS 402 through, as one example, a Web-based interface 430. It will be readily apparent to one of ordinary skill in the relevant art that numerous other interfaces (e.g., a data feed, etc.) are easily possible.

Through flexible, extensible, and dynamically updatable configuration information a WorkFlow component may be quickly and easily realized to support any number of activities. For example, WorkFlows might be configured to support the creation of new DSGs; to support the identification of active DSGs; to support the comparison of active DSGs to MS profile elements to identify matches; to support the generation and dispatch of notification SMS, MMS, etc. messages; to support the participation of MSs in DSGs; to support various billing transactions; to support the generation of scheduled and/or on-demand reports; etc. The specific WorkFlows that were just described are exemplary only; it will be readily apparent to one of ordinary skill in the relevant art that numerous other WorkFlow arrangements, alternatives, etc. are easily possible.

A SP may maintain a repository (e.g., a database) into which selected details of all administrative, messaging, etc. activities may be recorded. Among other things, such a repository may be used to support scheduled (e.g., daily, weekly, etc.) and/or on-demand reporting with report results delivered (to, for example, a service user) through SMS, MMS, etc. messages; through e-mail; through a Web-based facility; etc.

It is important to note that while aspects of the discussion that was presented above referenced the use of SCs, it will be readily apparent to one of ordinary skill in the relevant art that TNs and other message address identifiers are equally applicable and, indeed, are fully within the scope of the present invention.

The discussion that was just presented referenced two specific wireless messaging paradigms—SMS and MMS. These paradigms potentially offer an incremental advantage over other paradigms in that native support for SMS and/or MMS is commonly found on a WD that a potential MS would be carrying. However, it is to be understood that it would be readily apparent to one of ordinary skill in the relevant art that other paradigms are fully within the scope of the present invention.

It is important to note that the hypothetical example that was presented above, which was described in the narrative and which was illustrated in the accompanying figures, is exemplary only. It will be readily apparent to one of ordinary skill in the relevant art that numerous alternatives to the presented example are easily possible and, indeed, are fully within the scope of the present invention.

The following list defines acronyms as used in this disclosure.

| Acronym | Meaning |
|---|---|
| AS | Application Server |
| BI | Billing Interface |
| CSC | Common Short Code |
| DBMS | Database Management System |
| DSG | Dynamic Social Group |
| GW | Gateway |
| IQ | Incoming Queue |
| LBS | Location-Based Service |
| MICV | Messaging Inter-Carrier Vendor |
| MMS | Multimedia Message Service |
| MS | Mobile Subscriber |
| ODBMS | Object Database Management System |
| OQ | Outgoing Queue |
| PC | Personal Computer |
| RDBMS | Relational Database Management System |
| SC | Short Code |
| SMS | Short Message Service |
| SP | Service Provider |
| TN | Telephone Number |
| WC | Wireless Carrier |
| WD | Wireless Device |
| WS | Web Server |
| WWW | World Wide Web |

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the relevant art in light of the above disclosure.

What is claimed is:

1. A method for managing Dynamic Social Groups, comprising:
generating within a Service Provider an indication of an occurrence of a Dynamic Social Group, said indication based at least in part on preference information previously supplied by a Mobile Subscriber;
processing said indication to obtain a processed indication;
generating a notification message in view of the processed indication; and
dispatching said notification message to a Wireless Device of said Mobile Subscriber.

2. The method of claim 1, wherein said preference information is defined by a Mobile Subscriber during a registration process.

3. The method of claim 2, wherein information gathered during said registration process includes at least one of Identifying Information, Preference Information, and Billing Information.

4. The method of claim 2, wherein information gathered during said registration process is preserved through a User Profile.

5. The method of claim 2, wherein said registration process is Web-based.

6. The method of claim 2, wherein said registration process includes a billing component.

7. The method of claim 1, wherein said notification message is a SMS message.

8. The method of claim 1, wherein said notification message is a MMS message.

9. The method of claim 1, wherein said notification message contains advertising and/or promotional material.

10. The method of claim 1, further comprising:
receiving a reply from said Mobile Subscriber;
processing said reply; and
conditionally joining said Mobile Subscriber to said Dynamic Social Group in response to said reply.

11. The method of claim 10, further comprising:
receiving a participation message from said Mobile Subscriber;
processing said participation message to obtain a processed message; and
conditionally dispatching said processed message to the members of said Dynamic Social Group.

12. The method of claim 11, wherein said participation message is a SMS message.

13. The method of claim 11, wherein said participation message is a MMS message.

14. The method of claim 11, wherein dispatched processed messages contain advertising and/or promotional material.

15. The method of claim 10, further comprising:
assigning a moderator to said Dynamic Social Group.

16. The method of claim 10, further comprising:
identifying a candidate Meeting Place to one or more members of said Dynamic Social Group.

17. The method of claim 10, further comprising:
establishing a side forum for one or more members of said Dynamic Social Group.

18. A method of managing a Dynamic Social Group, comprising:
determining whether a mobile subscriber, who has previously registered to be associated with a predetermined Dynamic Social Group, should be notified that the predetermined Dynamic Social Group is forming;
sending at least one of a short message service (SMS) and a multimedia message service (MMS) message to the mobile subscriber inviting the mobile subscriber to join the Dynamic Social Group;
receiving from the mobile subscriber input to be made available to the Dynamic Social Group; and
making the input from the mobile subscriber available to the Dynamic Social Group.

19. The method of claim 18, further comprising supplying a different version of the input from the mobile subscriber to at least one member of the Dynamic Social Group.

20. The method of claim 18, further comprising generating a billing transaction.
